(19) United States
(12) Patent Application Publication
(10) Pub. No.: US 2026/0252973 A1
(43) Pub. Date: Aug. 27, 2026

(54) ESTIMATION METHOD, COMPUTER PROGRAM, AND INFORMATION PROCESSING APPARATUS

(71) Applicant: SHIMADZU GENERAL SERVICES, Inc., Kyoto-shi (JP)

(72) Inventors: Yasuhiro MITO, Kyoto-shi (JP); Takanori MOCHIZUKI, Kyoto-shi (JP)

(21) Appl. No.: 19/163,587

(22) PCT Filed: Dec. 22, 2023
(86) PCT No.: PCT/JP2023/046081

§ 371 Date: Sep. 9, 2025

(30) Foreign Application Priority Data
Mar. 10, 2023 (JP) 2023-037665
Aug. 24, 2023 (JP) 2023-136394

(51) Int. Cl. G06N 20/20

(52) U.S. Cl. CPC G06N 20/20

(57) ABSTRACT

An estimation method for estimating a retention time of a specific target component comprises a step of acquiring an HSP of the specific target component, a step of acquiring respective HSPs of a specific stationary phase and a specific mobile phase, and a step of acquiring an estimation result of an index related to the retention time of the specific target component by inputting the respective HSPs of the specific target component, the specific stationary phase, and the specific mobile phase into a machine learning model. The machine learning model may have been subjected to a machine learning process with respective HSPs of a target component, a stationary phase, and a mobile phase as explanatory variables and an index related to the retention time of the target component as an objective variable.

### TECHNICAL FIELD

The present invention relates to the estimation of the retention time of a target component in a chromatograph.

### BACKGROUND ART

Conventionally, various studies have been made on the estimation of parameters in chromatography. For example, Japanese Patent No. 6110380 (Patent Literature 1) discloses a technology for predicting a retention index related to the retention time of a component eluted in chromatography (hereinafter, also referred to as a “target component”) using the KRI index (Kovats retention index) of the component.

Japanese Patent No. 6796842 (Patent Literature 2) discloses a technology for calculating the Hansen Solubility Parameters (HSP) of a substance from its structural formula. Furthermore, attempts have been made to estimate retention time from the HSP distance, and software (HSPiP) for estimating the HSP of an unknown compound is also commercially available.

Hiroshi Yamamoto, “YMB Simulator Physical Property Estimation Function,” [online], Jun. 1, 2011, searched on Dec. 13, 2022, Internet <URL: https://www.pirika.com/Chemistry/JP/TCPE/YMB.html> (Non-Patent Literature 1) discloses that HSPiP has a built-in algorithm that infers physical properties by the YMB method and can calculate various physical quantities of an unknown compound based on the type and number of functional groups, etc.

Hiroshi Yamamoto, “High-Performance Liquid Chromatography and Hansen Solubility Parameters (HSP),” [online], Sep. 9, 2009, searched on Dec. 13, 2022, Internet <URL: https://www.pirika.com/HSP/JP/Examples/Docs/HPLC.html> (Non-Patent Literature 2) discloses that, for software such as that disclosed in Patent Literature 2, by calculating various physical quantities of a target component using the SMILES notation of the target component, calculating HSP using said physical quantities, and correcting the calculated value of HSP using the molecular volume, the correlation between the estimated retention time and the actual value becomes higher.

### CITATION LIST

### Patent Literature

Patent Literature 1: Japanese Patent No. 6110380

Patent Literature 2: Japanese Patent No. 6796842

### Non-Patent Literature

Non-Patent Literature 1: Hiroshi Yamamoto, “YMB Simulator Physical Property Estimation Function,” [online], Jun. 1, 2011, searched on Dec. 13, 2022, Internet <URL: https://www.pirika.com/Chemistry/JP/TCPE/YMB.html>

Non-Patent Literature 2: Hiroshi Yamamoto, “High-Performance Liquid Chromatography and Hansen Solubility Parameters (HSP),” [online], Sep. 9, 2009, searched on Dec. 13, 2022, Internet <URL: https://www.pirika.com/HSP/JP/Examples/Docs/HPLC.html>

### SUMMARY OF INVENTION

### Technical Problem

However, conventional techniques have been considered to lack convenience. That is, the estimation of HSP by the method described in Non-Patent Literature 1 requires complex calculations because it necessitates the calculation of various physical quantities of the target component. Furthermore, the retention time prediction method described in Non-Patent Literature 2 has low accuracy and has not reached a level where it can be put into practical use.

The present invention has been conceived in view of such circumstances, and an object thereof is to provide a technology that improves convenience in estimating the retention time of a target component in chromatography.

### Solution to Problem

According to one aspect of the present disclosure, there is provided an estimation method for estimating the retention time of a specific target component in chromatography that uses a specific stationary phase and a specific mobile phase, the method comprising: a step of acquiring Hansen Solubility Parameters (HSP) of the specific target component; a step of acquiring the respective HSPs of the specific stationary phase and the specific mobile phase; and a step of acquiring an estimation result of an index related to the retention time of the specific target component by inputting the respective HSPs of the specific target component, the specific stationary phase, and the specific mobile phase into a machine learning model, wherein the machine learning model has been subjected to a machine learning process with the respective HSPs of the target component, the stationary phase, and the mobile phase as explanatory variables and an index related to the retention time of the target component as an objective variable.

According to another aspect of the present disclosure, there is provided an estimation method for estimating the Hansen Solubility Parameters (HSP) of a substance, the method comprising: a step of acquiring the SMILES notation of the substance; and a step of acquiring an estimation result of the HSP of the substance by inputting the SMILES notation of the substance into an estimation model, wherein the estimation model has been subjected to a machine learning process with the SMILES notation as an explanatory variable and the HSP as an objective variable.

According to yet another aspect of the present disclosure, there is provided a computer program which, when executed by a control circuit of a computer, causes the computer to implement the above-described estimation method.

According to still another aspect of the present disclosure, there is provided an information processing apparatus comprising a control circuit and a storage device storing a computer program executed by the control circuit, wherein the computer program, when executed by the control circuit, causes the information processing apparatus to implement the above-described estimation method.

### Advantageous Effects of Invention

According to one aspect of the present disclosure, a technology is provided that improves the accuracy of estimating the retention time of a target component in chromatography, or that improves the convenience in estimating the retention time by enabling the simple implementation of HSP calculation.

### BRIEF DESCRIPTION OF DRAWINGS

FIG. 1 is a diagram for explaining an overview of retention time estimation according to an embodiment of the present disclosure.

FIG. 2 is a diagram showing an example of the hardware configuration of an information processing apparatus 1.

FIG. 3 is a diagram showing an example of the configuration of an HSP estimation model 2.

FIG. 4 is a flowchart of an example of processing executed in the information processing apparatus 1.

FIG. 5 is a flowchart of a subroutine for step S20 in FIG. 4.

FIG. 6 is a flowchart of a subroutine for step S40 in FIG. 4.

FIG. 7 is a diagram for explaining a specific example of SMILES notation used in the machine learning process of the HSP estimation model 2.

FIG. 8 is a diagram for explaining the results of estimation by the HSP estimation model 2.

FIG. 9 is a diagram for explaining the results of estimation by a retention time estimation model 3.

FIG. 10 is a diagram showing the estimation results by the retention time estimation model 3 together with the estimation results of other methods.

FIG. 11 is a flowchart of another example of processing executed in the information processing apparatus 1.

FIG. 12 is a flowchart of a subroutine for step S60 (estimation of retention time in gradient elution) in FIG. 11.

FIG. 13 is a diagram showing a specific example of the output of retention time estimation results.

FIG. 14 is a flowchart of a subroutine for step S80 (report output) in FIG. 11.

FIG. 15 is a diagram showing an example of a report to be output.

FIG. 16 is a flowchart of yet another example of processing executed in the information processing apparatus 1.

### DESCRIPTION OF EMBODIMENTS

Hereinafter, embodiments of the present disclosure will be described in detail with reference to the drawings. In the drawings, the same or corresponding parts are denoted by the same reference numerals, and a description thereof will not be repeated.

### Overview of Retention Time Estimation

In the present embodiment, a numerical value related to the retention time of a substance when the substance is eluted using a certain mobile phase in a certain stationary phase in chromatography is estimated. In this specification, the term “target component” may be used for a substance to be eluted in chromatography.

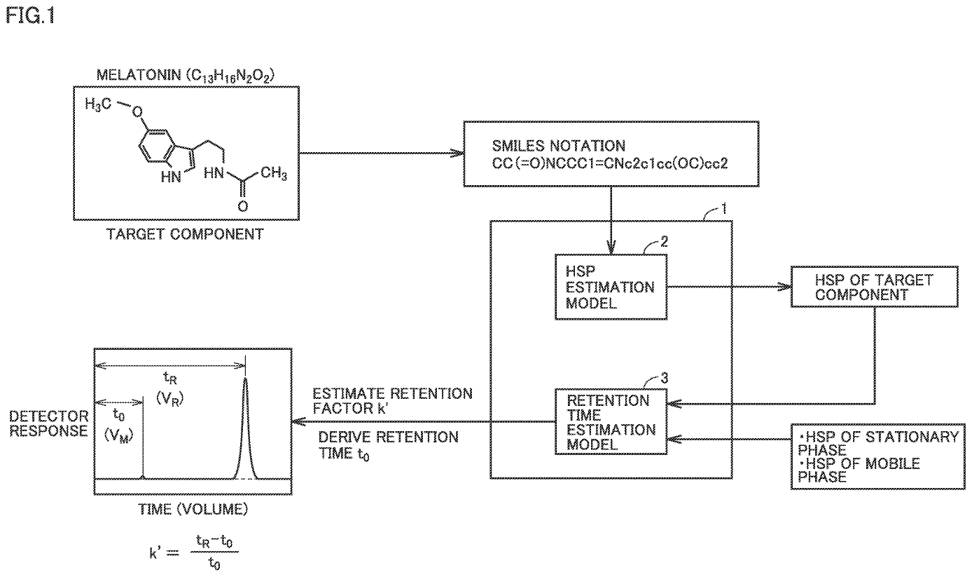

FIG. 1 is a diagram for explaining an overview of retention time estimation according to an embodiment of the present disclosure. FIG. 1 shows an information processing apparatus 1. The information processing apparatus 1 estimates the retention time of a specific target component in a column where a specific stationary phase and a specific mobile phase are used.

More specifically, the SMILES notation of a specific target component is input into the information processing apparatus 1. The SMILES notation of the target component may be acquired from a database such as PubChem (https://pubchem.ncbi.nlm.nih.gov/).

The information processing apparatus 1 includes an HSP estimation model 2 and a retention time estimation model 3. The HSP estimation model 2 has been subjected to a machine learning process for a plurality of target components, with the SMILES notation as an explanatory variable and the value of HSP as an objective variable. The retention time estimation model 3 has been subjected to a machine learning process, with the HSP of the target component, the HSP of the stationary phase, and the HSP of the mobile phase as explanatory variables, and the logarithm of the retention factor (k′) of the target component (logk′) as an objective variable. The explanatory variables of the retention time estimation model 3 may also include other variables (for example, the molecular volume of the target component).

The information processing apparatus 1 acquires an estimation result of the HSP of the specific target component by applying the SMILES notation of the specific target component to the HSP estimation model 2.

The HSP of the specific target component, the HSP of the specific stationary phase, and the HSP of the specific mobile phase are input into the information processing apparatus 1. Each HSP may be an estimation result output from the HSP estimation model 2, or may be acquired from an information source other than the HSP estimation model 2.

The information processing apparatus 1 acquires an estimation result of the logarithm of the retention factor of the specific target component by applying the HSP of the specific target component, the HSP of the specific stationary phase, and the HSP of the specific mobile phase to the retention time estimation model 3. The information processing apparatus 1 acquires an estimation result of the retention factor from the logarithm of the retention factor (k′), and then derives (calculates) an estimation result of the retention time (tR) of the specific target component using the estimation result of the retention factor and a given hold-up time (t0).

### Hardware Configuration

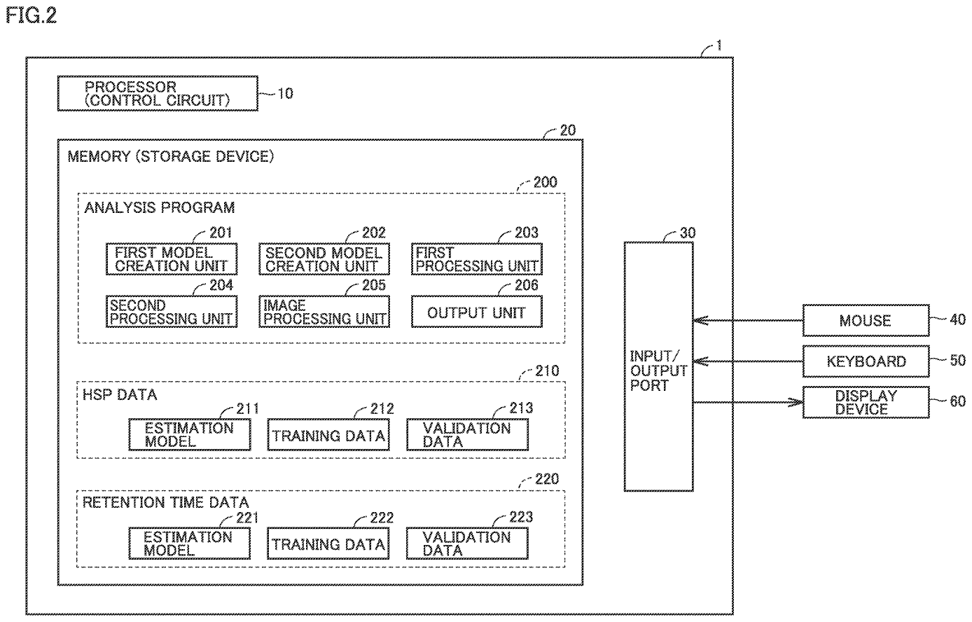

FIG. 2 is a diagram showing an example of the hardware configuration of the information processing apparatus 1. The information processing apparatus 1 includes a processor 10, which is an example of a control circuit, a memory 20 that functions as a storage unit, and an input/output port 30. A mouse 40, a keyboard 50, and a display device 60 are connected to the input/output port 30. One or more terminal devices may be connected to the input/output port 30 via the Internet or a local area network.

The information processing apparatus 1 is configured based on, for example, a personal computer. The information processing apparatus 1 may be configured by a server that can be accessed from one or more terminal devices via a network such as the Internet.

An analysis program 200, HSP data 210, and retention time data 220 are non-transitorily stored in the memory 20.

By executing the analysis program 200, the processor 10 functions as a first model creation unit 201, a second model creation unit 202, a first processing unit 203, a second processing unit 204, an image processing unit 205, and an output unit 206.

The first model creation unit 201 performs a machine learning process for the HSP estimation model 2. The second model creation unit 202 performs a machine learning process for the retention time estimation model 3. The first processing unit 203 acquires an estimation result of the HSP of the target component using the HSP estimation model 2. The second processing unit 204 acquires an estimation result of the retention time of the target component using the retention time estimation model 3. The image processing unit 205 creates image data including various estimation results. The output unit 206 outputs a display signal including the image data to the display device 60 via the input/output port 30.

The HSP data 210 includes an estimation model 211. The estimation model 211 includes data for configuring the HSP estimation model 2 and a group of parameters. At least a part of the group of parameters is updated in the machine learning process.

The HSP data 210 includes a plurality of training samples. The plurality of training samples are classified into training data 212 and validation data 213. In one implementation, 80% of the plurality of training samples are classified into the training data 212, and 20% are classified into the validation data 213. Each of the plurality of training samples includes the SMILES notation of a target component and the HSP value of the target component.

The retention time data 220 includes an estimation model 221. The estimation model 221 includes data for configuring the retention time estimation model 3 and a group of parameters. At least a part of the group of parameters is updated in the machine learning process.

The retention time data 220 includes a plurality of training samples. The plurality of training samples are classified into training data 212 and validation data 213. In one implementation, 80% of the plurality of training samples are classified into the training data 212, and 20% are classified into the validation data 213. Each of the plurality of training samples includes the HSP of a target component, the HSP of a stationary phase, the HSP of a mobile phase, and the logarithm of the retention time of the target component in the combination of the stationary phase and the mobile phase.

### HSP Estimation Model

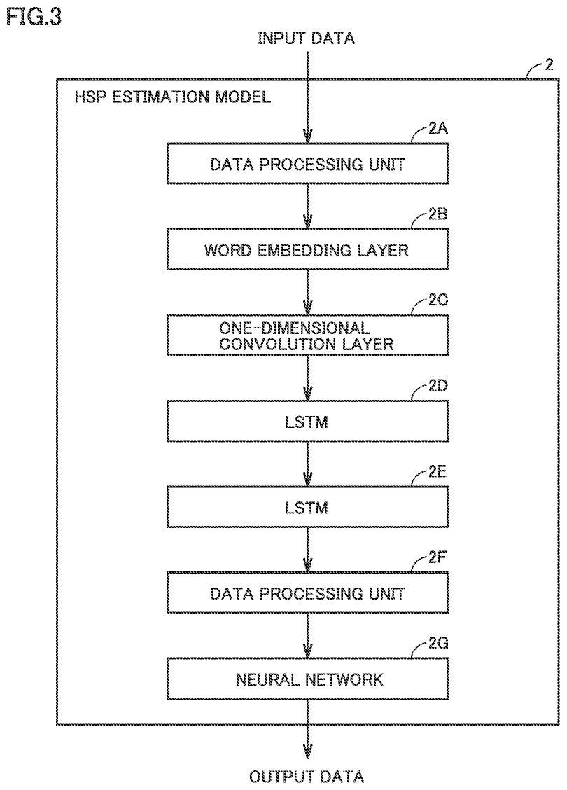

FIG. 3 is a diagram showing an example of the configuration of the HSP estimation model 2. The example in FIG. 3 follows the SMILES2vec method. The HSP includes three types of parameters: a dispersion term (dD), a polarity term (dP), and a hydrogen bonding term (dH). The HSP estimation model 2 has settings corresponding to each of the three types of parameters. That is, the HSP estimation model 2 is substantially composed of three models: a model for the dispersion term, a model for the polarity term, and a model for the hydrogen bonding term.

The information processing apparatus 1 acquires the three types of parameters as the HSP of the target component by providing the SMILES notation of the target component to each of the three models.

The HSP estimation model 2 may be generated for each column temperature (set temperature of the column oven). More specifically, as training data used for generating the HSP estimation model 2, training data consisting of a set of SMILES notation and parameters classified for each column temperature may be used. The parameters classified for each column temperature mean that they are associated with the column temperature at which the parameters were acquired. The column temperature may be one value selected from a plurality of predetermined temperature values. More specifically, one column temperature may be selected from a plurality of temperature values in 5° C. increments (40° C., 35° C., 30° C., 25° C., 20° C. . . . ). Each of the model for the dispersion term, the model for the polarity term, and the model for the hydrogen bonding term may be configured by a group corresponding to each of a plurality of column temperatures. For example, the group of models for the dispersion term may include models corresponding to five types of temperatures (a model for column temperature 40° C., a model for column temperature 35° C., a model for column temperature 30° C., a model for column temperature 25° C., and a model for column temperature 20° C.). Similarly, the group of models for the polarity term and the group of models for the hydrogen bonding term may also each include models corresponding to five types of temperatures.

An example of the configuration of each model constituting the HSP estimation model 2 is shown in FIG. 3.

In the example of FIG. 3, input data (SMILES notation) is input into the HSP estimation model 2. The model to be used is selected based on the parameter to be estimated (model for the dispersion term, model for the polarity term, or model for the hydrogen bonding term). The information processing apparatus 1 may accept a setting of the column temperature to be estimated from a user. In that case, the information processing apparatus 1 may select a model corresponding to the column temperature to be estimated as the model to be used. The input data is converted into a one-hot representation in a data processing unit 2A.

Next, in a word embedding layer 2B, each character is converted into a vector. Thereby, the one-hot representation is converted into two-dimensional data.

Next, the two-dimensional data is input into a Long Short Term Memory (LSTM) 2D, and further input into an LSTM 2E.

The data output from the LSTM 2E is converted into one-dimensional data in a data processing unit 2F. The data output from the data processing unit 2F is input into a neural network 2G. A Dropout layer for preventing overfitting is inserted in the neural network 2G.

The HSP estimation model 2 outputs an estimation result of the HSP based on the output of the neural network 2G.

The estimation of HSP using the HSP estimation model 2 is different from the method of calculating the HSP of individual components by focusing on their physicochemical properties, as disclosed in Non-Patent Literature 1, in that it uses a model that has been subjected to a machine learning process using the SMILES notation of many components. As a result, the HSP estimation means by the HSP estimation model 2 is expected to provide a simpler means while its accuracy is equivalent to that of conventional methods.

### Retention Time Estimation Model

The retention time estimation model 3 is configured as a model following, for example, a random forest algorithm. The retention time estimation model 3 is generated by a machine learning process.

In the machine learning process, the respective HSPs of the target component, the stationary phase, and the mobile phase are used as explanatory variables, and the logarithm of the retention factor of the target component is used as the objective variable.

When the mobile phase is a mixed solution of two types of components, the “HSP of the mobile phase” is prepared by combining the HSPs of the two types of components, as shown in formula (1).

$$[ dDm , dPm , dHm ] = [ ( a * dD 1 + b * dD 2 ) , ( a * dP 1 + b * dP 2 ) , ( a * dH 1 + b * dH 2 ) ] / ( a + b ) \qquad ( 1 )$$

In formula (1), “dD” represents the dispersion term in HSP. “dP” represents the polarity term in HSP. “dH” represents the hydrogen bonding term in HSP. The subscript “m” represents the mixed solution. The subscript “1” represents one of the two types of components, and the subscript “2” represents the other of the two types of components. “a” and “b” represent the volume fractions of the one component and the other component in the mixed solution. More specifically, the volume fraction of the one component is “a/(a+b),” and the volume fraction of the other component is “b/(a+b).”

In addition to the HSPs of the target component, the stationary phase, and the mobile phase, other variables may be used as explanatory variables for the retention time estimation model 3. The other variables may be one or more variables selected from the group consisting of, for example, the pH of the mobile phase, the column temperature in column chromatography, and the molecular volume of the target component.

### Processing Flow

### <Main Routine>

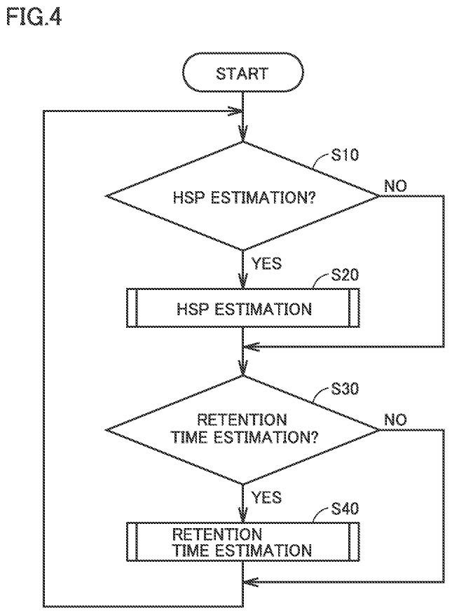

FIG. 4 is a flowchart of an example of processing executed in the information processing apparatus 1. In one implementation, the processing of FIG. 4 is executed by the processor 10 executing a given program in the information processing apparatus 1. In one implementation, the processing of FIG. 4 starts when an operation to launch a given application program is performed in the information processing apparatus 1.

In step S10, the information processing apparatus 1 determines whether an instruction to estimate HSP has been input. If the information processing apparatus 1 determines that an instruction to estimate HSP has been input (YES in step S10), it proceeds to step S20; otherwise (NO in step S10), it proceeds to step S30.

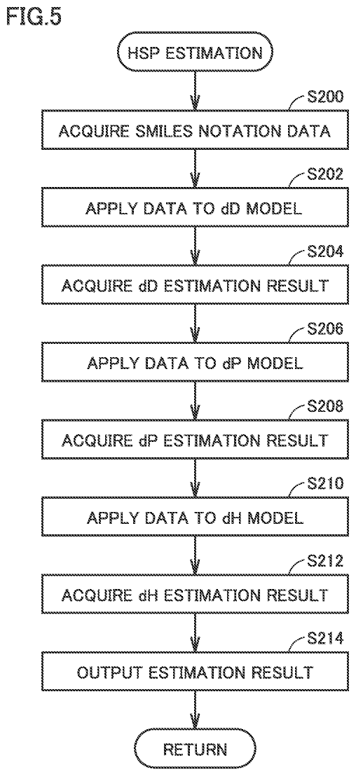

In step S20, the information processing apparatus 1 performs HSP estimation. The processing content of step S20 will be described later with reference to FIG. 5.

In step S30, the information processing apparatus 1 determines whether an instruction to estimate retention time has been input. If the information processing apparatus 1 determines that an instruction to estimate retention time has been input (YES in step S30), it proceeds to step S40; otherwise (NO in step S30), it returns to step S10.

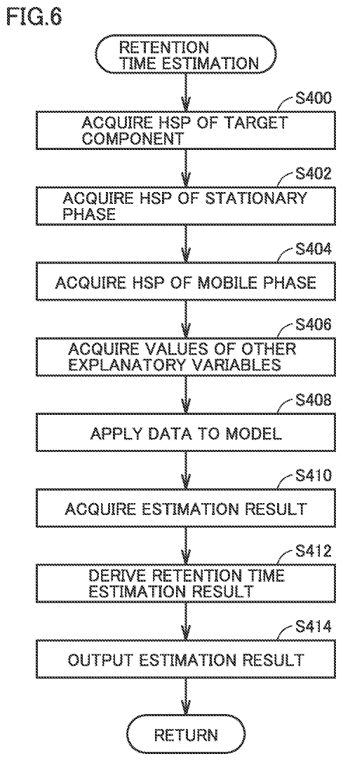

In step S40, the information processing apparatus 1 performs retention time estimation. The processing content of step S40 will be described later with reference to FIG. 6. Thereafter, the information processing apparatus 1 returns control to step S10.

The information processing apparatus 1 may simultaneously accept the input of both an HSP estimation instruction and a retention time estimation instruction for a specific target component. For example, the information processing apparatus 1 accepts the input of both the HSP estimation instruction and the retention time estimation instruction, along with the input of the SMILES notation of the specific target component and values other than the HSP of the target component for the explanatory variables of the retention time estimation model 3 (HSP of the specific stationary phase, the specific mobile phase, and other necessary variables).

### <HSP Estimation>

FIG. 5 is a flowchart of a subroutine for step S20 in FIG. 4.

In step S200, the information processing apparatus 1 acquires SMILES notation data. In one implementation, the data is input via the keyboard 50.

In step S202, the information processing apparatus 1 applies the SMILES notation to the HSP estimation model 2, which functions as a model for the dispersion term (dD model).

In step S204, the information processing apparatus 1 acquires an estimation result for the parameter dD that constitutes the HSP.

In step S206, the information processing apparatus 1 applies the SMILES notation to the HSP estimation model 2, which functions as a model for the polarity term (dP model).

In step S208, the information processing apparatus 1 acquires an estimation result for the parameter dP that constitutes the HSP.

In step S210, the information processing apparatus 1 applies the SMILES notation to the HSP estimation model 2, which functions as a model for the hydrogen bonding term (dH model).

In step S212, the information processing apparatus 1 acquires an estimation result for the parameter dH that constitutes the HSP.

In step S214, the information processing apparatus 1 outputs the estimation results of the three types of parameters acquired in steps S204, S208, and S212 as the HSP estimation result. An example of the output is a display on the display device 60.

Thereafter, the information processing apparatus 1 returns control to FIG. 4.

### <Retention Time Estimation>

FIG. 6 is a flowchart of a subroutine for step S40 in FIG. 4.

In step S400, the information processing apparatus 1 acquires the HSP of the target component for which the retention time is to be estimated (specific target component). The information processing apparatus 1 may acquire the HSP of the target component by accepting input via the keyboard 50 or the like, or may acquire it as an estimation result from the HSP estimation model 2.

In step S402, the information processing apparatus 1 acquires the HSP of the stationary phase that is scheduled to be used for the specific target component (specific stationary phase). The information processing apparatus 1 may acquire the HSP of the target component by accepting input via the keyboard 50 or the like, or may acquire it as an estimation result from the HSP estimation model 2.

In step S404, the information processing apparatus 1 acquires the HSP of the mobile phase that is scheduled to be used for the specific target component (specific mobile phase). The information processing apparatus 1 may acquire the HSP of the target component by accepting input via the keyboard 50 or the like, or may acquire it as an estimation result from the HSP estimation model 2.

When the mobile phase is a mixed liquid of a plurality of types of solvents, the information processing apparatus 1 may calculate the HSP of the mixed liquid in step S404. More specifically, in step S404, it accepts the input of the HSP and volume fraction of each of the plurality of types of solvents, and calculates the HSP of the mixed liquid according to formula (1) using them.

In step S406, the information processing apparatus 1 acquires, as necessary, the values of explanatory variables other than HSP used in the retention time estimation model 3 (pH of the specific mobile phase, column temperature in column chromatography, and/or molecular volume of the target component).

In step S408, the information processing apparatus 1 applies the data acquired in steps S400, S402, S404 (, S406) to the retention time estimation model 3.

In step S410, the information processing apparatus 1 acquires an estimation result of the retention factor (or its logarithm) as a result of the application of the data in step S408.

In step S412, the information processing apparatus 1 derives an estimation result of the retention time of the specific target component using the retention factor acquired in step S410.

In step S414, the information processing apparatus 1 outputs the estimation result derived in step S412. An example of the output is displaying it on the display device 60. Another example is transmitting the data to an external device. Thereafter, the information processing apparatus 1 returns control to FIG. 4.

In the processing described above, the retention time is output as the estimation result. The object to be output as the estimation result may be the retention factor or the logarithm of the retention factor.

The information processing apparatus 1 may perform the control of steps S400 to S412 for each of a plurality of target components. As a result, the estimation result of the retention time for each of the plurality of target components in chromatography using a common mobile phase and stationary phase is derived. Then, in step S414, the information processing apparatus 1 may collectively output the estimation results for the plurality of target components.

When the control of steps S400 to S412 is performed for isocratic elution, the collective output of the estimation results for a plurality of target components allows the user to determine whether the elution of the plurality of target components should be performed as gradient elution in the actual elution. For example, if there is an appropriate difference in the retention times of the plurality of target components in the estimation result of isocratic elution, the user can determine that the actual elution can be performed as isocratic elution. On the other hand, if there is no appropriate difference in the retention times of the plurality of target components in the estimation result of isocratic elution, the user can determine that the actual elution should be performed as gradient elution.

When outputting the estimation results for a plurality of target components, the information processing apparatus 1 may perform the above-described determination of whether the actual elution can be performed as isocratic elution or should be performed as gradient elution, and output the result of the determination together with the estimation results. The information processing apparatus 1 may use a predetermined threshold related to the retention time interval for the determination.

### EXAMPLES

### HSP Estimation

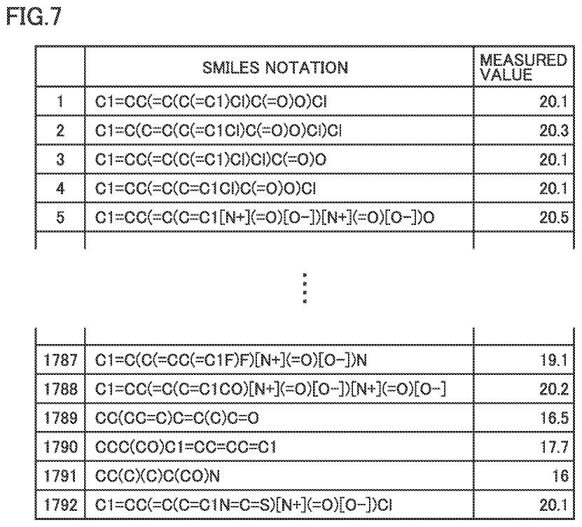

An example of training and using the HSP estimation model 2 will be described. In this example, the SMILES notations of 1792 types of target components were used as training samples for the machine learning process of the HSP estimation model 2. FIG. 7 is a diagram for explaining a specific example of SMILES notation used in the machine learning process of the HSP estimation model 2. In the data shown in FIG. 7, each training sample is configured by a pair of a SMILES notation and a measured value of one type of parameter constituting the HSP (dispersion term (dD), polarity term (dP), or hydrogen bonding term (dH)).

For the machine learning process of the dispersion term model among the HSP estimation models 2, 1792 pieces of data, each consisting of a pair of a SMILES notation and a measured value of the dispersion term parameter, were used as training samples. For the machine learning process of the polarity term model, 1792 pieces of data, each consisting of a pair of a SMILES notation and a measured value of the polarity term parameter, were used as training samples. For the machine learning process of the hydrogen bonding term model, 1792 pieces of data, each consisting of a pair of a SMILES notation and a measured value of the hydrogen bonding term parameter, were used as training samples.

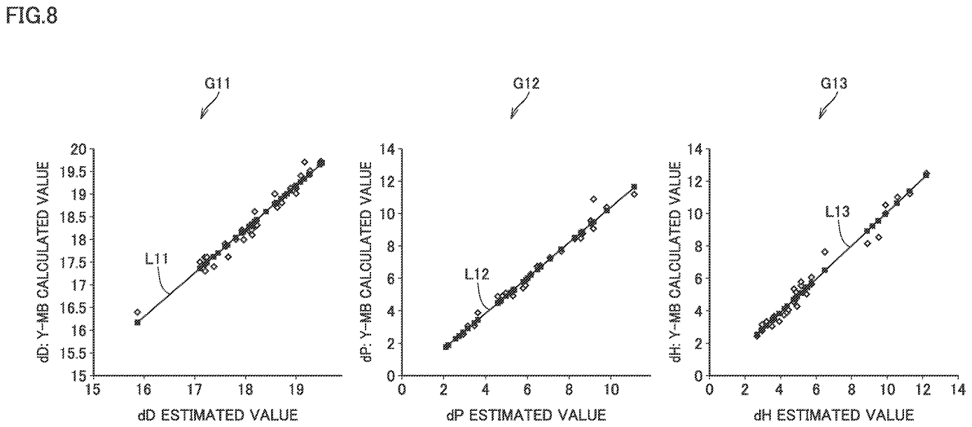

FIG. 8 is a diagram for explaining the results of estimation by the HSP estimation model 2. FIG. 8 shows three graphs G11, G12, and G13. Each of the graphs G11, G12, and G13 represents the estimated values of dD, dP, and dH, respectively. Each of the graphs G11, G12, and G13 shows the results for 34 types of target components (benzyl alcohol, phenol, 3-phenylpropanol, p-chlorophenol, acetophenone, benzonitrile, nitrobenzene, methyl benzoate, anisole, benzene, p-nitrotoluene, p-nitrobenzyl chloride, toluene, benzophenone, bromobenzene, naphthalene, ethylbenzene, p-xylene, p-dichlorobenzene, propylbenzene, n-butylbenzene, diethylformamide, methylparaben, ethylparaben, propylparaben, butylparaben, acetanilide, propiophenone, butyrophenone, valerophenone, hexanophenone, heptanophenone, octanophenone, ibuprofen).

In each of the graphs G11, G12, and G13, the horizontal axis represents the estimated value of the parameter by the HSP estimation model 2, and the vertical axis represents the calculated value of the parameter acquired using the YMB simulator described in Non-Patent Literature 1. Each of the lines L11, L12, and L13 represents a regression line. The hollow plots represent the estimated values. The black plots represent the values on the regression line corresponding to the estimated values.

As shown in graphs G11, G12, and G13, the estimated HSP values by the HSP estimation model 2 were close to the estimated HSP values acquired using the YMB simulator.

Thus, the estimation means of the HSP estimation model 2 can be said to be a simple means that can replace the YMB simulator, which requires complex physicochemical calculations.

### Retention Time Estimation

An example of training and using the retention time estimation model 3 will be described. In this example, a model following a random forest regression algorithm was used as the retention time estimation model 3. For the machine learning process of the retention time estimation model 3, 1020 types of data sets were used as training samples. The 1020 types of data sets were configured by combinations of the above-mentioned 34 types of target components and 30 types of mobile phases. The 30 types of mobile phases were composed of mixed solutions of water and acetonitrile, with the mixing ratio of acetonitrile varying by 2% from 20% to 78%. Assuming an ODS (octadecylsilyl) column, octadecane was adopted as the stationary phase.

Each of the 1020 types of data sets included, as explanatory variables, 10 types of variables (HSP of the target component (dD, dP, dH), HSP of the stationary phase (dD, dP, dH), HSP of the mobile phase (dD, dP, dH), and molecular volume of the target component), and included, as the objective variable, the logarithm of the retention factor of the target substance.

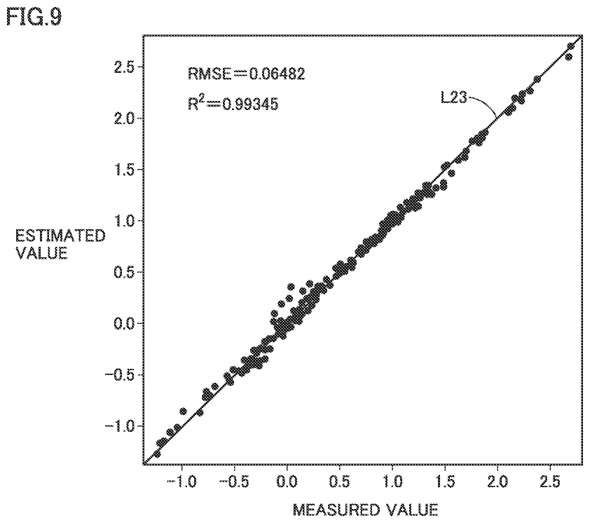

FIG. 9 is a diagram for explaining the results of estimation by the retention time estimation model 3. In the graph shown in FIG. 9, the vertical axis represents the logarithm value of the retention factor (logk′), which is an example of the estimation result by the retention time estimation model 3, and the horizontal axis represents the measured value of the logarithm of the retention factor. Line L23 represents a regression line.

In the example of FIG. 9, the value of the Root Mean Square Error (RMSE) was 0.06482, and the value of the coefficient of determination (R2) was 0.99345. Thus, the estimation by the retention time estimation model 3 can be said to be highly accurate.

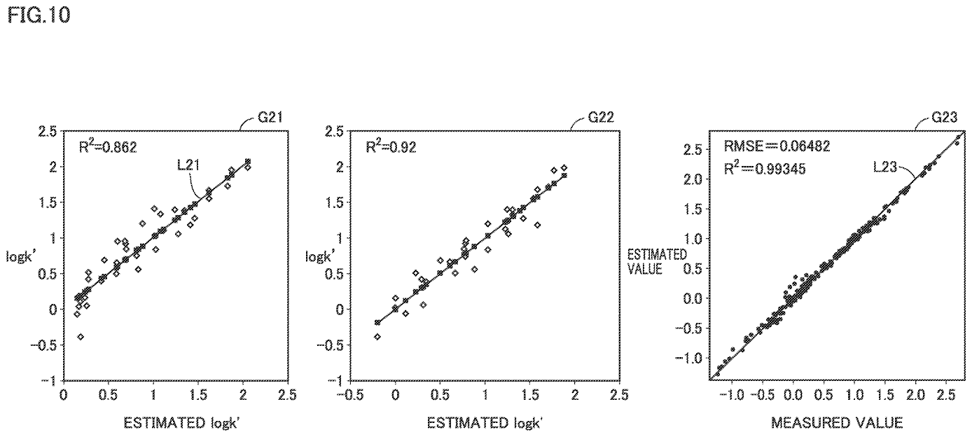

FIG. 10 is a diagram showing the estimation results by the retention time estimation model 3 together with the estimation results of other methods. FIG. 10 shows three graphs G21, G22, and G23. Graphs G21 and G22 show estimation results of other methods for reference. Graph G23 is simply a reduced version of the graph shown in FIG. 9. Each of the lines L21, L22, and L23 represents a regression line.

In graphs G21 and G22, the vertical axis represents the measured value of the logarithm of the retention factor, and the horizontal axis represents the estimated value of the logarithm of the retention factor.

Graph G21 shows the estimation results by simple regression analysis according to the following formula (2) for the same 34 types of target components as in graph G23.

$$log {k}^{′} = C 1 + C 2 * molecular volume of target component * ( D 1 - D 2 ) \qquad ( 2 )$$

In formula (2), “C1” and “C2” represent given constants. “D1” represents the HSP distance between the mobile phase and the target component. “D2” represents the HSP distance between the stationary phase and the target component. The HSP distance (HSP_dis), when one HSP is represented by the vector (dD1, dP1, dH1) and the other HSP is represented by the vector (dD2, dP2, dH2), is calculated according to the following formula (3).

$$HSP\_dis = {\{ 4 * {( dD 1 - dD 2 )}^{2} + {( dP 1 - dP 2 )}^{2} + {( dH 1 - dH 2 )}^{2} \}}^{0.5} \qquad ( 3 )$$

Graph G22 shows the estimation results by multiple regression analysis according to the following formula (4) for the same 34 types of target components as in graph G23.

$$log {k}^{′} = C 1 + C 2 * molecular volume of target component + C 3 * D 1 + C 4 * D 2 \qquad ( 4 )$$

In formula (4), “C1”, “C2”, and “C3” represent given constants. “D1”, as in formula (2), represents the HSP distance between the mobile phase and the target component. “D2”, as in formula (2), represents the HSP distance between the stationary phase and the target component.

In the example of graph G21, the value of the coefficient of determination R² was 0.862. In the example of graph G22, the value of the coefficient of determination R² was 0.92. On the other hand, in the example of graph G23, the value of the coefficient of determination R² was 0.99345, which was higher than in graphs G21 and G22.

In the example of graph G23, in addition to the HSPs of the target component, the stationary phase, and the mobile phase, the molecular volume of the target component was used as an explanatory variable. In this regard, even when the molecular volume was not used as an explanatory variable, when the pH of the mobile phase and/or the column temperature were used instead of the molecular volume as explanatory variables, and also when the pH of the mobile phase and/or the column temperature were used in addition to the molecular volume as explanatory variables, the estimation results by the retention time estimation model 3 showed a similar tendency compared to the estimation results by simple regression analysis and multiple regression analysis.

From this, it is considered that the retention time estimation model 3 can handle the non-linear relationship between HSP and retention time, and can estimate the retention factor (retention time) with higher accuracy than the above-mentioned simple regression analysis and multiple regression analysis.

Furthermore, when a model following a random forest algorithm was used as the retention time estimation model 3, particularly high estimation accuracy was obtained.

Also, SMILES notation can distinguish isomers of a compound from each other. Therefore, when HSP is derived using SMILES notation, HSP can be derived for each isomer of the compound, and thereby, the estimation result of the retention time derived using HSP can also be derived for each isomer of the compound. By using the estimation results of the retention time derived in this way, it becomes possible to identify the type of isomer of a compound based on the difference in retention times in chromatography.

### Processing Flow (2)

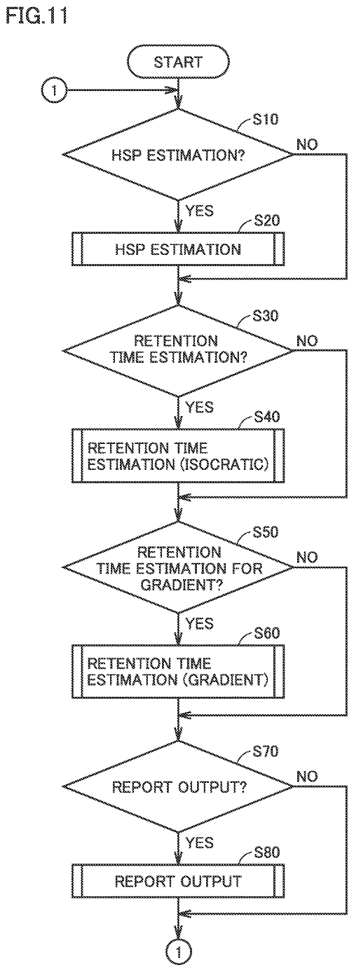

FIG. 11 is a flowchart of another example of processing executed in the information processing apparatus 1. The example in FIG. 11 describes the estimation of retention time in isocratic elution and the estimation of retention time in gradient elution separately, unlike the example in FIG. 4. The example in FIG. 11 also describes the output of a report regarding the estimation results. Hereinafter, the content of the processing shown in FIG. 11 will be described.

The respective controls of steps S10 to S40 in the processing shown in FIG. 11 correspond to the respective controls of steps S10 to S40 described with reference to FIG. 4. In the example of FIG. 11, the “instruction to estimate retention time” in step S30 means the estimation of retention time in isocratic elution. In the example of FIG. 11, if the information processing apparatus 1 determines in step S30 that an instruction to estimate retention time in isocratic elution has been input (YES in step S30), it proceeds to step S40; otherwise (NO in step S30), it proceeds to step S50.

In step S40, the information processing apparatus 1 performs estimation of retention time in isocratic elution. Thereafter, the information processing apparatus 1 proceeds to step S50.

In step S50, the information processing apparatus 1 determines whether an instruction to estimate retention time in gradient elution has been input. If the information processing apparatus 1 determines that an instruction to estimate retention time in gradient elution has been input (YES in step S50), it proceeds to step S60; otherwise (NO in step S50), it proceeds to step S70.

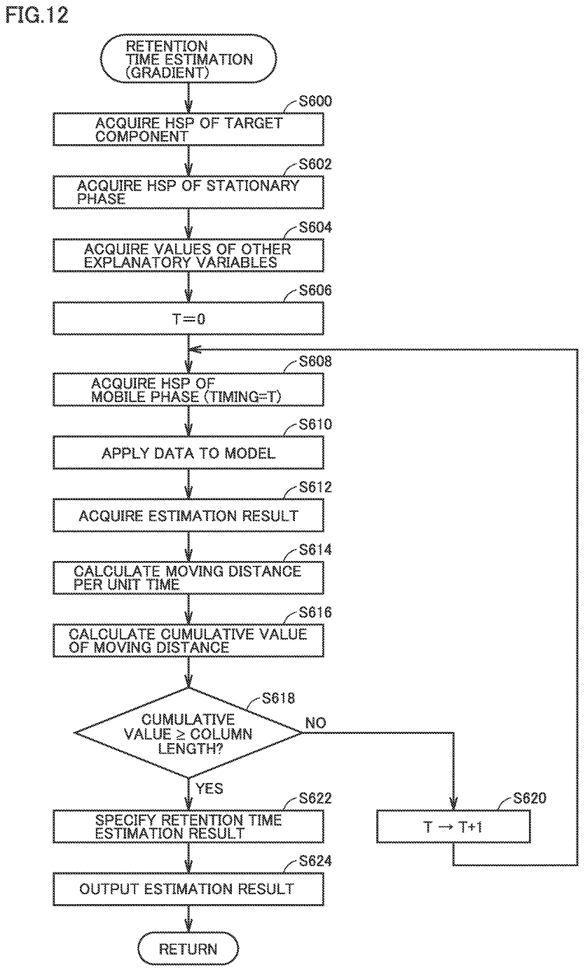

In step S60, the information processing apparatus 1 performs estimation of retention time in gradient elution. The content of the estimation of retention time in gradient elution in step S60 will be described later with reference to FIG. 12. Thereafter, the information processing apparatus 1 proceeds to step S70.

In step S70, the information processing apparatus 1 determines whether an instruction to output a report on the estimation results has been input. If the information processing apparatus 1 determines that an instruction to output a report has been input (YES in step S70), it proceeds to step S80; otherwise (NO in step S70), it returns to step S10.

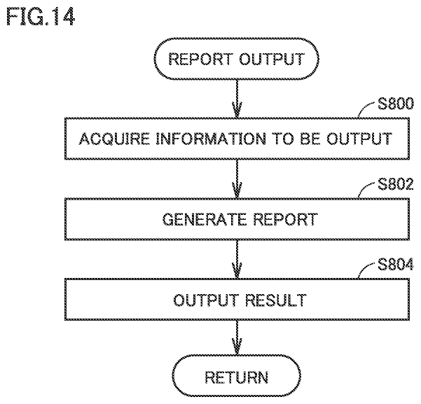

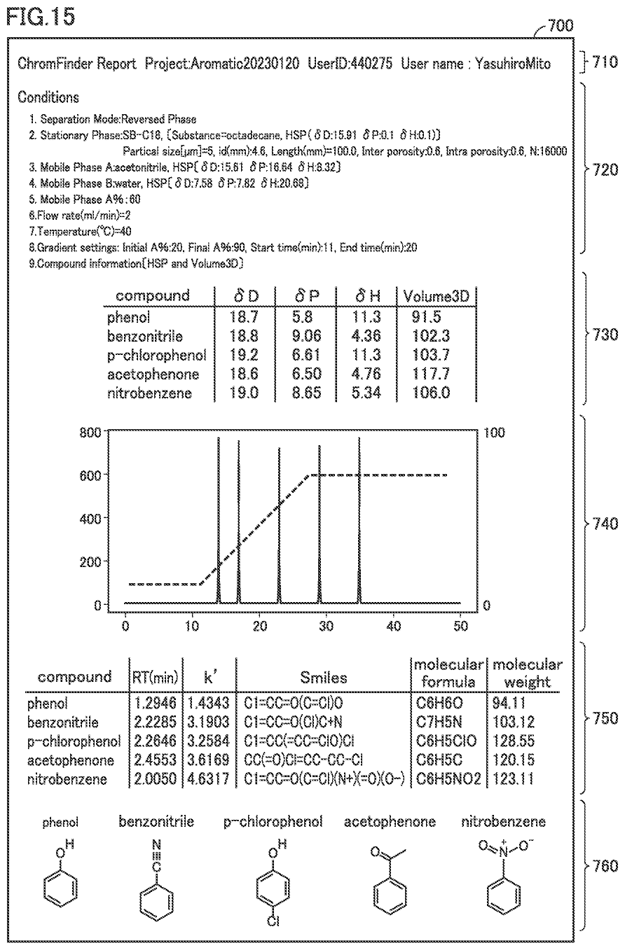

In step S80, the information processing apparatus 1 performs report output. The content of the report output in step S80 will be described later with reference to FIGS. 14 and 15. Thereafter, the information processing apparatus 1 returns control to step S10.

### Estimation of Retention Factor in Gradient Elution

FIG. 12 is a flowchart of a subroutine for step S60 (estimation of retention time in gradient elution) in FIG. 11.

In step S600, the information processing apparatus 1 acquires the HSP of the target component for which the retention time is to be estimated.

In step S602, the information processing apparatus 1 acquires the HSP of the stationary phase.

In step S604, the information processing apparatus 1 acquires, as necessary, the values of explanatory variables other than HSP used in the retention time estimation model 3 (pH of the specific mobile phase, column temperature in column chromatography, and/or molecular volume of the target component).

In step S606, the information processing apparatus 1 sets “0” as the value of a variable T. The variable T represents the time used for gradient elution. More specifically, the variable T represents the number of unit times corresponding to the length of elapsed time from the start of elution. For example, if 5 seconds is set as the unit time, T=2 represents 10 seconds as the elapsed time from the start of elution. That is, T=2 represents the timing 10 seconds after the start of elution.

In gradient elution, the proportions of a plurality of types of solutions in the mobile phase change over time. Information specifying the change in the proportions of the plurality of types of solutions in the mobile phase over time is registered in the information processing apparatus 1 as a condition for estimation. The information is input from, for example, a user.

An example of the above information is information that defines the proportions of a first solution and a second solution for each unit time when the first solution and the second solution are used as the mobile phase.

For example, assume that the following is specified as the above information: the change in proportions starts 10 seconds after the start of elution, the change in proportion every 5 seconds is 5%, the initial proportion of the first solution is 100%, and the initial proportion of the second solution is 0%. In this case, until 10 seconds after the start of elution, the breakdown of the mobile phase is 100% of the first solution and 0% of the second solution. The breakdown of the mobile phase 15 seconds after the start of elution is 95% of the first solution and 5% of the second solution. The breakdown of the mobile phase 20 seconds after the start of elution is 90% of the first solution and 10% of the second solution. The breakdown of the mobile phase 25 seconds after the start of elution is 85% of the first solution and 15% of the second solution. Also, the breakdown of the mobile phase 105 seconds after the start of elution is 5% of the first solution and 95% of the second solution. Then, the breakdown of the mobile phase from 110 seconds after the start of elution onwards is 100% of the first solution and 0% of the second solution.

In step S608, the information processing apparatus 1 acquires the HSP of the mobile phase at the timing represented by the variable T. More specifically, the information processing apparatus 1 specifies the proportions of the plurality of solutions in the mobile phase at the timing represented by the variable T, according to the above-mentioned conditions for estimation. Then, the information processing apparatus 1 acquires, as the HSP of the mobile phase, the HSP of a mixed liquid in which the plurality of solutions are mixed at the specified proportions, according to the above-mentioned formula (1).

In step S610, the information processing apparatus 1 applies the data acquired in steps S600, S602, S604, and S608 to the retention time estimation model 3.

In step S612, the information processing apparatus 1 acquires an estimation result of the retention factor (or its logarithm) as a result of the application of the data in step S610.

In step S614, the information processing apparatus 1 derives an estimation result of the retention time of the specific target component using the retention factor acquired in step S610.

In step S616, the information processing apparatus 1 calculates the moving distance of the target component in the column in the latest unit time using the estimation result derived in step S614. More specifically, the information processing apparatus 1 calculates the time related to movement in the column using the retention factor, and calculates the moving speed of the retention factor from the calculated time and the column length. Then, the information processing apparatus 1 calculates the product of the moving speed and the unit time as the moving distance.

In step S618, the information processing apparatus 1 determines whether the cumulative value of the moving distance of the target component is equal to or greater than the column length. If the information processing apparatus 1 determines that the cumulative value of the moving distance of the target component is equal to or greater than the column length (YES in step S618), it proceeds to step S622; otherwise (NO in step S618), it proceeds to step S620.

In step S620, the information processing apparatus 1 increments the value of the variable T by 1 and returns control to step S606.

In step S622, the information processing apparatus 1 specifies the time derived as the product of the latest value of the variable T and the unit time as the estimation result of the retention time. The product of the latest value of the variable T and the unit time corresponds to the cumulative value of the unit times when the cumulative value of the moving distance of the target component reaches the column length.

In step S624, the information processing apparatus 1 outputs the estimation result and returns control to FIG. 11.

In the processing of FIG. 12 described above, the estimation result of the retention time for gradient elution is output.

### Specific Example of Output of Retention Time Estimation Results

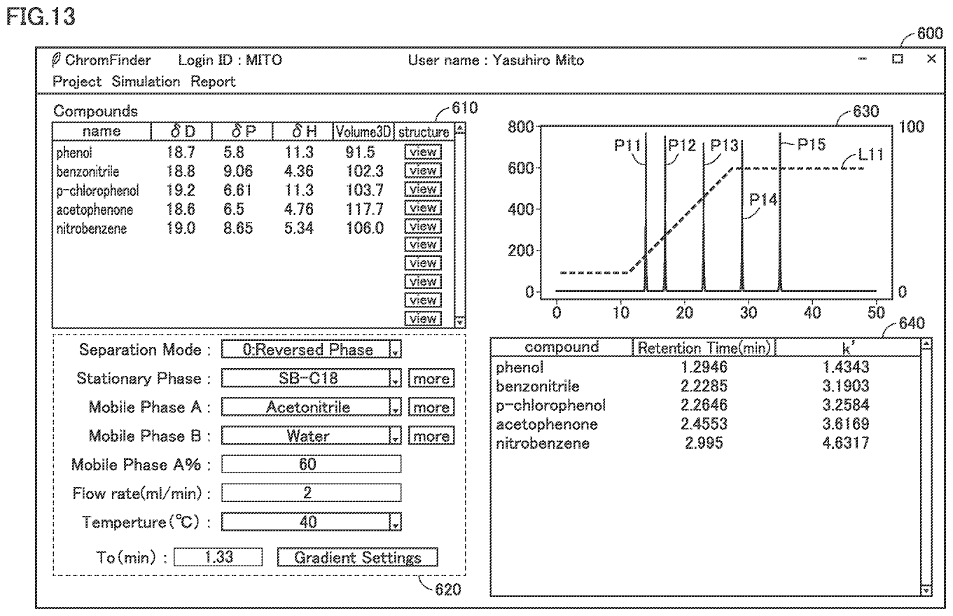

FIG. 13 is a diagram showing a specific example of the output of retention time estimation results. The information processing apparatus 1 may perform retention time estimation by executing the control of steps S600 to S622 for each of a plurality of target components. Then, in step S624, the information processing apparatus 1 may generate display information for one screen using the retention time estimation results of the plurality of target components. A screen 600 shown in FIG. 13 shows the estimation results for a plurality of target components. The screen 600 is displayed on, for example, the display device 60. Also, information input via the mouse 40 or the keyboard 50 is displayed on the screen 600.

The screen 600 includes four areas 610, 620, 630, and 640. Area 610 displays information for specifying a target component. Area 620 displays the elution conditions used for the estimation. Area 630 displays a chromatograph created using the estimation results. Area 640 displays the numerical values of the estimation results.

In one implementation, an instruction to estimate retention time in gradient elution may be input in a state where target components are input in area 610 and conditions are input in area 620. The information processing apparatus 1 may start the processing of FIG. 12 in response to the input of the instruction. Then, the information processing apparatus 1 may output the estimation result by updating the display of the screen 600 to add the estimation result specified in the processing of FIG. 12.

The display contents of each of the areas 610 to 640 in FIG. 13 will be described. In area 610, the names of five types of compounds (phenol, benzonitrile, p-chlorophenol, acetophenone, nitrobenzene) are shown as five types of target components. Area 610 also shows the HSP (dD, dP, dH) and molecular volume (Volume 3D) values of each target component.

The conditions displayed in area 620 include the elution mode (Separation Mode: Reversed Phase), the type of stationary phase (Stationary Phase: SB-C18), the types of two solutions used as the mobile phase (Mobile Phase A: Acetonitrile, Mobile Phase B: Water), the proportion of solution A in isocratic elution (Mobile Phase A %: 60), the flow rate of the mobile phase (Flow rate (ml/min): 20), and the column temperature (Temperature (° C.): 40). Area 620 may also display the conditions for estimation (those mentioned in connection with the description of the variable T in step S606).

In area 630, in addition to a chromatogram including peaks corresponding to each target component (five peaks P11 to P15), a line L1 indicating the change in the proportion of one of the two types of solutions in the mobile phase is displayed. The chromatogram is one that the information processing apparatus 1 has simulatedly generated to include peaks representing the retention times specified as the estimation results for each target component.

In area 640, along with the retention time (Retention Time) of each target component, the value of the retention factor (k′) is shown.

### Report Output

FIG. 14 is a flowchart of a subroutine for step S80 (report output) in FIG. 11.

In step S800, the information processing apparatus 1 acquires information to be output. In one implementation, the information to be output includes information specifying each of one or more target components, information specifying the mobile phase, information specifying the stationary phase, and conditions used for estimation.

In step S802, the information processing apparatus 1 generates a report including the estimation results of the retention times for one or more target components, based on the output target information acquired in step S800.

In step S804, the information processing apparatus 1 outputs the report as a result of step S802. Thereafter, the information processing apparatus 1 returns control to FIG. 11.

FIG. 15 is a diagram showing an example of a report to be output. A report 700 includes areas 710, 720, 730, 740, 750, and 760.

In area 710, bibliographic information is displayed. In one implementation, the bibliographic information includes a name given by the user to the report to be output (Aromatic20230120), a user ID (440275), and a user name (YasuhiroMito).

In area 720, the conditions used for the retention time estimation are displayed. In the example of FIG. 15, “Separation Mode” represents the elution mode, and “Reversed Phase” is displayed as its value. “Stationary Phase” represents the stationary phase, and “SB-C18” is displayed as its value. In the example of FIG. 15, additional information about the stationary phase (HSP value (SD: 15.91, 8P: 0.1, 8H: 0.1), Partical size [μm]=5, id(mm): 4.6, Length(mm)=100.0, Inter porosity: 0.6, Intra porosity: 0.6, N: 16000) is also displayed. In particular, Length means the length of the region where the stationary phase is packed, that is, the length of the column.

“Mobile Phase A” represents one type of solution among the plurality of types of solutions constituting the mobile phase, and “acetonitrile” is displayed as its value. In the example of FIG. 15, additional information for this solution (HSP value (δD: 15.61, δP: 16.64, δH: 8.32)) is also displayed.

“Mobile Phase B” represents another type of solution among the plurality of types of solutions constituting the mobile phase, and “water” is displayed as its value. In the example of FIG. 15, additional information for this solution (HSP value (δD: 7.58, δP: 7.82, δH: 20.68)) is also displayed.

“Mobile Phase A %” represents the proportion of solution A in the case of isocratic elution, and “60” is displayed as its value. “Flow rate(ml/min)” represents the flow rate of the mobile phase, and “2” is displayed as its value. “Temperature(C)” represents the column temperature, and “40” is displayed as its value. “Gradient settings” represents the settings for gradient elution, and as its values, the initial value of the proportion of solution A (the type of solution represented by “Mobile Phase A” above) in the mobile phase “Initial A %: 20,” the final value of the proportion of solution A in the mobile phase “Final A %: 90,” the start and end times of the change in the proportions of the plurality of solutions in the mobile phase from the start of elution (Start time(min): 11, End time(min): 20), and the type of variables to be used for estimation (Compound information [HSP and Volume3D]) are displayed.

In area 730, a table including the HSP values and molecular volume values for each of one or more target components to be estimated is displayed.

In area 740, a simulated chromatogram generated using the estimation results is displayed. This chromatogram is generated to have peaks representing the estimation results of the retention time of each of the one or more target components, in the same manner as described for area 640 of FIG. 13. Area 740 also displays a dashed line representing the change in the proportion of one type of solution in the mobile phase, which is composed of a plurality of types of solutions.

In area 750, the estimation results for each of the one or more target components to be estimated are displayed. The estimation results include the retention time (RT) and the retention factor (k′). Area 740 further displays the SMILES notation (Smiles), molecular formula, and molecular weight for each target component.

In area 760, the structural formula of each of the one or more target components to be estimated is displayed.

As described above, the output report includes a simulated chromatogram generated using the retention times of one or more target components. This provides the user with the estimation results in an easy-to-understand manner. The output report includes, for a plurality of target components, the structural formula of each target component in addition to the estimated retention times. This allows the user to evaluate the differences in the estimated retention times among the plurality of target components while considering the differences in their structural formulas.

In the report output of FIG. 14, the information processing apparatus 1 may use retention time estimation results stored in advance in the memory 20, or may perform retention time estimation. When performing retention time estimation in the report output, the information processing apparatus 1 performs the retention time estimation in step S40 and/or step S60 in response to acquiring the information to be output in step S600, that is, in step S602.

In the report output of FIG. 14, the information processing apparatus 1 may acquire, as the information to be output, both the estimation conditions related to isocratic elution and those related to gradient elution. In this case, the information processing apparatus 1 generates a report for each of the one or more target components using both the estimation result of the retention time in isocratic elution and the estimation result of the retention time in gradient elution. In the report generated in this way, both the conditions for isocratic elution and gradient elution are displayed in area 720. Also, in area 740, a chromatogram generated using the retention time in isocratic elution, a chromatogram generated using the retention time in gradient elution, and a gradient curve representing the change in the proportion of one solution in the mobile phase are displayed.

### Processing Flow (3)

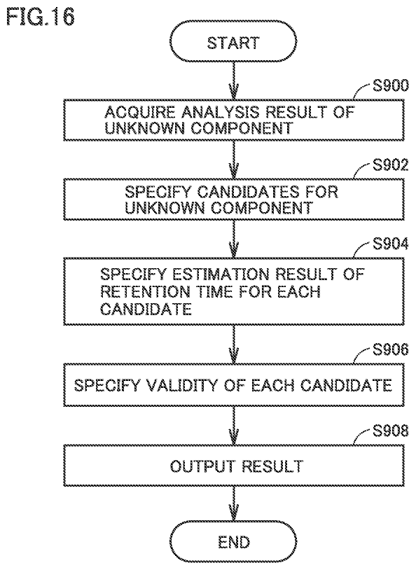

FIG. 16 is a flowchart of still another example of processing performed in the information processing apparatus 1. The processing of FIG. 16 is performed to provide information regarding the validity of each of one or more candidates being an unknown component. In one implementation, the information processing apparatus 1 starts the processing of FIG. 16 in response to the selection of a specific menu during the execution of a given application.

In step S900, the information processing apparatus 1 acquires the analysis result of chromatography of an unknown component. The analysis result is a measured value from chromatography. The analysis result may be input from the user to the information processing apparatus 1 via the mouse 40 or the keyboard 50, or may be transmitted from an external device to the information processing apparatus 1.

In step S902, the information processing apparatus 1 specifies one or more candidates for the compound assumed for the unknown component. The information processing apparatus 1 may realize the specification of one or more candidates by accepting the input of one or more candidates from the user and recognizing the input one or more candidates.

The information processing apparatus 1 may realize the specification of one or more candidates by selecting one or more compounds from among a plurality of compounds registered in the memory 20 based on the mass spectrometry result of the unknown component. For example, the information processing apparatus 1 acquires a mass spectrogram as a result of mass spectrometry, specifies a peak in the mass spectrogram, and specifies the m/z corresponding to the specified peak. Then, the information processing apparatus 1 selects one or more compounds having a molecular weight equal to the specified m/z value from among the plurality of compounds registered in the memory 20 as one or more candidates for the unknown component.

In step S904, the information processing apparatus 1 specifies the estimation result of the retention time for each of the one or more candidates specified in step S902. The estimation result is based on the same conditions as the analysis result acquired in step S900 (for example, the mobile phase and stationary phase are the same). The information processing apparatus 1 may acquire the conditions of the chromatography under which the analysis result was obtained, in addition to the analysis result in step S900. In step S904, the information processing apparatus 1 may perform the retention time estimation in step S40 and/or step S60 for each of the one or more candidates.

In step S906, the information processing apparatus 1 compares the analysis result acquired in step S900 with the estimated retention time of each candidate specified in step S904, and for each candidate, specifies the validity of that candidate being the unknown component. As one example, the information processing apparatus 1 may calculate the difference between the estimation result and the analysis result acquired in step S900 for each candidate, and may specify the above validity as a ranking in ascending order of the difference. As another example, the above validity may be specified by classifying the compound with the smallest difference between the estimation result and the analysis result acquired in step S900 among the one or more candidates as a final candidate, and classifying the remaining compounds as non-candidates.

In step S908, the information processing apparatus 1 outputs the result of the validity specification in step S906. Thereafter, the information processing apparatus 1 terminates the processing of FIG. 16.

As described above, in the processing of FIG. 16, the validity of each of one or more candidates being an unknown component is output. For the validity judgment, the analysis result of the chromatography of the unknown component and the estimation result of the retention time of the one or more candidates are used. The user can refer to the output validity of each of the one or more candidates for the identification of the unknown component.

### Aspects

Those skilled in the art will understand that the plurality of exemplary embodiments described above are specific examples of the following aspects.

(Item 1) An estimation method for estimating a retention time of a specific target component in chromatography using a specific stationary phase and a specific mobile phase, the method comprising:
a step of acquiring an HSP of the specific target component;
a step of acquiring respective HSPs of the specific stationary phase and the specific mobile phase; and
a step of acquiring an estimation result of an index related to the retention time of the specific target component by inputting the respective HSPs of the specific target component, the specific stationary phase, and the specific mobile phase into a machine learning model,
wherein the machine learning model may have been subjected to a machine learning process with respective HSPs of a target component, a stationary phase, and a mobile phase as explanatory variables and an index related to the retention time of the target component as an objective variable.

According to the estimation method described in item 1, a technology is provided that improves the accuracy of estimating the retention time of a target component in chromatography. This improves the convenience of retention time estimation.

(Item 2) In the estimation method according to item 1, the machine learning model may be a classification model by random forest.

According to the estimation method described in item 2, a technology is provided that more reliably improves the accuracy of estimating the retention time of a target component in chromatography.

(Item 3) In the estimation method according to item 1 or 2, the index may be a logarithm of a retention factor.

According to the estimation method described in item 3, retention time estimation can be performed more easily.

(Item 4) In the estimation method according to any one of items 1 to 3,
the machine learning model may have been subjected to a machine learning process further using a pH of the mobile phase as an explanatory variable,
the estimation method may further comprise a step of acquiring the pH of the specific mobile phase, and
in the step of acquiring the estimation result, the pH of the specific mobile phase may be further input into the machine learning model.

According to the estimation method described in item 4, a technology is provided that more reliably improves the accuracy of estimating the retention time of a target component in chromatography.

(Item 5) In the estimation method according to any one of items 1 to 4,
the machine learning model may have been subjected to a machine learning process further using a column temperature as an explanatory variable,
the estimation method may further comprise a step of acquiring a column temperature at which the specific stationary phase is used, and
in the step of acquiring the estimation result, the column temperature at which the specific stationary phase is used may be further input into the machine learning model.

According to the estimation method described in item 5, a technology is provided that more reliably improves the accuracy of estimating the retention time of a target component in chromatography.

(Item 6) In the estimation method according to any one of items 1 to 5,
the machine learning model may have been subjected to a machine learning process further using a molecular volume of the target component as an explanatory variable,
the estimation method may further comprise a step of acquiring the molecular volume of the specific target component, and
in the step of acquiring the estimation result, the molecular volume of the specific target component may be further input into the machine learning model.

According to the estimation method described in item 6, a technology is provided that more reliably improves the accuracy of estimating the retention time of a target component in chromatography.

(Item 7) In the estimation method according to any one of items 1 to 6,
the step of acquiring the HSP of the specific target component includes:
acquiring a SMILES notation of the specific target component; and
acquiring an estimation result of the HSP of the specific target component by inputting the SMILES notation of the specific target component into an estimation model,
wherein the estimation result of the HSP of the specific target component is used as the HSP of the specific target component, and
the estimation model may have been subjected to a machine learning process with a SMILES notation as an explanatory variable and an HSP as an objective variable.

According to the estimation method described in item 7, the estimation of HSP is simply performed in the estimation of the retention time of a target component in chromatography.

(Item 8) In the estimation method according to item 7,
the HSP may include a plurality of parameters, and
in the step of acquiring the HSP of the specific target component, each of the plurality of parameters may be estimated by applying a setting corresponding to each of the plurality of parameters to the estimation model.

According to the estimation method described in item 8, a technology is provided that more reliably improves the accuracy of estimating the retention time of a target component in chromatography.

(Item 9) In the estimation method according to item 7 or 8,
the estimation model may be generated for each of a plurality of column temperatures, the step of acquiring the SMILES notation of the specific target component may include accepting a setting of a column temperature to be estimated, and
the acquiring of the estimation result of the HSP of the specific target component may include selecting an estimation model corresponding to the column temperature to be estimated from the estimation models for each of the plurality of column temperatures.

According to the estimation method described in item 9, a model customized to the column temperature to be estimated is used as the model used for HSP estimation. This improves the accuracy of HSP estimation.

(Item 10) In the estimation method according to any one of items 1 to 9,
the step of acquiring the HSP of the specific target component may further include acquiring HSPs of one or more other target components,
the step of acquiring the estimation result of the index related to the retention time of the specific target component may further include acquiring estimation results of the index for the one or more other target components, and
the estimation method may further comprise a step of outputting the respective estimation results of the index for the specific target component and the one or more other target components.

According to the estimation method described in item 10, estimation results of retention times under common conditions are provided for a plurality of components.

(Item 11) In the estimation method according to item 10,
the step of outputting may include:
performing a judgment on a necessity of gradient elution based on the respective estimation results of the index for the specific target component and the one or more other target components; and
outputting a result of the judgment.

According to the estimation method described in item 11, information that assists the user in judging the necessity of gradient elution is provided.

(Item 12) In the estimation method according to item 10 or 11, the step of outputting may include outputting a retention time as the estimation result of the index.

According to the estimation method described in item 12, information that is intuitively easy for a user to understand about chromatography is provided.

(Item 13) In the estimation method according to item 12, the retention time may include a retention time in isocratic elution and a retention time in gradient elution.

According to the estimation method described in item 13, information is provided for a user to judge whether to adopt isocratic elution or gradient elution for the elution of a plurality of target components.

(Item 14) In the estimation method according to item 12 or 13, the retention time may be output in a chromatogram format.

According to the estimation method described in item 14, the estimation results of the retention time are provided to the user in a form that is intuitively easy to understand regarding chromatography.

(Item 15) In the estimation method according to item 14, the step of outputting may include outputting conditions for obtaining the estimation result of the index so as to be displayed on the same screen as the retention time.

According to the estimation method described in item 15, information that can be used for evaluating the estimation results can be provided to the user together with the estimation results.

(Item 16) In the estimation method according to any one of items 12 to 15, the step of outputting may include outputting a structural formula of a compound of each of the specific target component and the one or more other target components.

According to the estimation method described in item 16, information that can be used for evaluating the estimation results can be provided to the user together with the estimation results in a form that is intuitively easy to understand.

(Item 17) In the estimation method according to any one of items 1 to 16,
the specific mobile phase includes a plurality of solvents,
a proportion of each of the plurality of solvents in the specific mobile phase is set for each of a plurality of unit times,
the estimation result of the index is a retention time,
the step of acquiring the estimation result of the index of the specific target component includes:
selecting one unit time from the plurality of unit times;
acquiring the estimation result of the index for the selected one unit time;
calculating a moving distance in a column of the specific target component based on the estimation result of the index acquired for the selected one unit time; and
performing a switching of the selected one unit time,
wherein, in the step of acquiring the estimation result of the index of the specific target component,
the switching is performed until a cumulative value of the moving distance reaches a predetermined column length, and
a cumulative value of the unit times when the cumulative value of the moving distance reaches the predetermined column length may be acquired as a final estimation result.

According to the estimation method described in item 17, a specific aspect for estimating the retention time in gradient elution is provided.

(Item 18) The estimation method according to any one of items 1 to 17, further comprising:
a step of acquiring an analysis result of chromatography of an unknown component; and
a step of specifying one or more candidates of the unknown component as the specific target component,
wherein, in the chromatography of the unknown component, a specific stationary phase and a specific mobile phase are used, and
the method may further comprise a step of specifying, for the one or more candidates, a validity of being the unknown component, based on the analysis result and the estimation result of the index corresponding to each of the one or more candidates.

According to the estimation method described in item 18, information useful for identifying an unknown component can be provided.

(Item 19) In the estimation method according to item 18, the step of specifying the one or more candidates may include selecting the one or more candidates based on a result of mass spectrometry of the unknown component.

According to the estimation method described in item 19, the burden on the user for specifying one or more candidates can be reduced.

(Item 20) An estimation method for estimating an HSP of a substance, the method comprising:
a step of acquiring a SMILES notation of the substance; and
a step of acquiring an estimation result of the HSP of the substance by inputting the SMILES notation of the substance into an estimation model,
wherein the estimation model may have been subjected to a machine learning process with a SMILES notation as an explanatory variable and an HSP as an objective variable.

According to the estimation method described in item 20, the estimation of HSP used for retention time estimation becomes simple, thereby providing a technology that improves the convenience of estimating the retention time of a target component in chromatography.

(Item 21) In the estimation method according to item 20,
the HSP includes a plurality of parameters, and
in the step of acquiring the HSP of the substance, each of the plurality of parameters may be estimated by applying a setting corresponding to each of the plurality of parameters to the estimation model.

According to the estimation method described in item 21, a technology is provided that more reliably improves the accuracy of estimating the retention time of a target component in chromatography.

(Item 22) In the estimation method according to item 20 or 21,
the estimation model is generated for each column temperature,
the step of acquiring the SMILES notation of the substance includes accepting a setting of a temperature to be estimated, and
the step of acquiring the estimation result of the HSP of the substance may include selecting an estimation model corresponding to the temperature to be estimated.

According to the estimation method described in item 22, a model customized to the temperature to be estimated is used as the model used for HSP estimation. This improves the accuracy of HSP estimation.

(Item 23) A computer program that, when executed by a control circuit of a computer, causes the computer to perform the estimation method according to any one of items 1 to 22.

According to the estimation method described in item 23, a technology is provided that improves the convenience of estimating the retention time of a target component in chromatography by improving the accuracy of estimating the retention time of the target component in chromatography or by simply performing the estimation of HSP.

(Item 24) An information processing apparatus comprising a control circuit and a storage device storing a computer program executed by the control circuit,
wherein the computer program, when executed by the control circuit, causes the information processing apparatus to perform the estimation method according to any one of items 1 to 22.

According to the information processing apparatus described in item 24, a technology is provided that improves the convenience of estimating the retention time of a target component in chromatography by improving the accuracy of estimating the retention time of the target component in chromatography or by simply performing the estimation of HSP.

The embodiments disclosed this time should be considered illustrative in all respects and not restrictive. The scope of the present disclosure is indicated by the claims rather than the description of the embodiments above, and all changes that come within the meaning and range of equivalency of the claims are intended to be embraced therein. Furthermore, each technology in the embodiments can be implemented alone or in combination with other technologies in the embodiments as much as possible, as needed.

### REFERENCE SIGNS LIST

1 Information processing apparatus, 2 HSP estimation model, 3 Retention time estimation model, 10 Processor, 20 Memory.

1. An estimation method for estimating a retention time of a specific target component in chromatography using a specific stationary phase and a specific mobile phase, the method comprising:
a step of acquiring Hansen Solubility Parameters (HSP) of the specific target component;
a step of acquiring respective HSPs of the specific stationary phase and the specific mobile phase; and
a step of acquiring an estimation result of an index related to the retention time of the specific target component by inputting the respective HSPs of the specific target component, the specific stationary phase, and the specific mobile phase into a machine learning model,
wherein the machine learning model has been subjected to a machine learning process with respective HSPs of a target component, a stationary phase, and a mobile phase as explanatory variables and an index related to the retention time of the target component as an objective variable,
wherein the machine learning model is a classification model by random forest.

2. (canceled)

3. The estimation method according to claim 1, wherein the index is a logarithm of a retention factor.

4. The estimation method according to claim 1,
wherein the machine learning model has been subjected to a machine learning process further using a pH of the mobile phase as an explanatory variable,
the method further comprising a step of acquiring the pH of the specific mobile phase, and
wherein, in the step of acquiring the estimation result, the pH of the specific mobile phase is further input into the machine learning model.

5. The estimation method according to claim 1,
wherein the machine learning model has been subjected to a machine learning process further using a column temperature as an explanatory variable,
the method further comprising a step of acquiring a column temperature at which the specific stationary phase is used, and
wherein, in the step of acquiring the estimation result, the column temperature at which the specific stationary phase is used is further input into the machine learning model.

6. The estimation method according to claim 1,
wherein the machine learning model has been subjected to a machine learning process further using a molecular volume of the target component as an explanatory variable,
the method further comprising a step of acquiring the molecular volume of the specific target component, and
wherein, in the step of acquiring the estimation result, the molecular volume of the specific target component is further input into the machine learning model.

7. The estimation method according to claim 1,
wherein the step of acquiring the HSP of the specific target component comprises:
acquiring a SMILES notation of the specific target component; and
acquiring an estimation result of the HSP of the specific target component by inputting the SMILES notation of the specific target component into an estimation model,
wherein the estimation result of the HSP of the specific target component is used as the HSP of the specific target component, and
the estimation model has been subjected to a machine learning process with a SMILES notation as an explanatory variable and an HSP as an objective variable.

8. The estimation method according to claim 7,
wherein the HSP comprises a plurality of parameters, and
wherein, in the step of acquiring the HSP of the specific target component, each of the plurality of parameters is estimated by applying a setting corresponding to each of the plurality of parameters to the estimation model.

9. The estimation method according to claim 7,
wherein the estimation model is generated for each of a plurality of column temperatures,
wherein the acquiring of the SMILES notation of the specific target component comprises accepting a setting of a column temperature to be estimated, and
wherein the acquiring of the estimation result of the HSP of the specific target component comprises selecting an estimation model corresponding to the column temperature to be estimated from the estimation models for each of the plurality of column temperatures.

10. The estimation method according to claim 1,
wherein the step of acquiring the HSP of the specific target component further comprises acquiring HSPs of one or more other target components,
wherein the step of acquiring the estimation result of the index related to the retention time of the specific target component further comprises acquiring estimation results of the index for the one or more other target components, and
the method further comprises a step of outputting the respective estimation results of the index for the specific target component and the one or more other target components.

11. The estimation method according to claim 10, wherein the step of outputting comprises:
performing a judgment on a necessity of gradient elution based on the respective estimation results of the index for the specific target component and the one or more other target components; and
outputting a result of the judgment.

12. The estimation method according to claim 10, wherein the step of outputting comprises outputting a retention time as the estimation result of the index.

13. The estimation method according to claim 12, wherein the retention time comprises a retention time in isocratic elution and a retention time in gradient elution.

14. The estimation method according to claim 12, wherein the retention time is output in a chromatogram format.

15. (canceled)

16. The estimation method according to claim 12, wherein the step of outputting comprises outputting a structural formula of a compound of each of the specific target component and the one or more other target components.

17. An estimation method for estimating a retention time of a specific target component in chromatography using a specific stationary phase and a specific mobile phase, the method comprising:
a step of acquiring Hansen Solubility Parameters (HSP) of the specific target component;
a step of acquiring respective HSPs of the specific stationary phase and the specific mobile phase; and
a step of acquiring an estimation result of an index related to the retention time of the specific target component by inputting the respective HSPs of the specific target component, the specific stationary phase, and the specific mobile phase into a machine learning model,
wherein the machine learning model has been subjected to a machine learning process with respective HSPs of a target component, a stationary phase, and a mobile phase as explanatory variables and an index related to the retention time of the target component as an objective variable,
wherein the specific mobile phase comprises a plurality of solvents,
wherein a proportion of each of the plurality of solvents in the specific mobile phase is set for each of a plurality of unit times,
wherein the estimation result of the index is a retention time, and
wherein the step of acquiring the estimation result of the index of the specific target component comprises:
selecting one unit time from the plurality of unit times;
acquiring the estimation result of the index for the selected one unit time;
calculating a moving distance in a column of the specific target component based on the estimation result of the index acquired for the selected one unit time; and
performing a switching of the selected one unit time,
wherein, in the step of acquiring the estimation result of the index of the specific target component,
the switching is performed until a cumulative value of the moving distance reaches a predetermined column length, and
a cumulative value of the unit times when the cumulative value of the moving distance reaches the predetermined column length is acquired as a final estimation result.

18. The estimation method according to claim 1, further comprising:
a step of acquiring an analysis result of chromatography of an unknown component; and
a step of specifying one or more candidates of the unknown component as the specific target component,
wherein, in the chromatography of the unknown component, the specific stationary phase and the specific mobile phase are used, and
the method further comprises a step of specifying, for the one or more candidates, a validity of being the unknown component, based on the analysis result and the estimation result of the index corresponding to each of the one or more candidates.

19. The estimation method according to claim 18, wherein the step of specifying the one or more candidates comprises selecting the one or more candidates based on a result of mass spectrometry of the unknown component.

20. An estimation method for estimating Hansen Solubility Parameters (HSP) of a substance, the method comprising:
a step of acquiring a SMILES notation of the substance; and
a step of acquiring an estimation result of the HSP of the substance by inputting the SMILES notation of the substance into an estimation model having an LSTM (Long Short Term Memory),
wherein the estimation model has been subjected to a machine learning process with a SMILES notation as an explanatory variable and an HSP as an objective variable.

21. The estimation method according to claim 20,
wherein the HSP comprises a plurality of parameters, and
wherein, in the step of acquiring the HSP of the substance, each of the plurality of parameters is estimated by applying a setting corresponding to each of the plurality of parameters to the estimation model.

22. The estimation method according to claim 20,
wherein the estimation model is generated for each temperature,
wherein the step of acquiring the SMILES notation of the substance comprises accepting a setting of a temperature to be estimated, and
wherein the step of acquiring the estimation result of the HSP of the substance comprises selecting an estimation model corresponding to the temperature to be estimated.

23-24. (canceled)
